(19) United States
(12) Patent Application Publication
(10) Pub. No.: US 2008/0187142 A1
(43) Pub. Date: Aug. 7, 2008

(54) FM TRANSMITTER

(75) Inventors: Hisashi FURUMOTO, Kyoto (JP); Tatsuya MANO, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/026,682

(22) Filed: Feb. 6, 2008

(30) Foreign Application Priority Data
Feb. 6, 2007 (JP) JP2007-026321
Nov. 29, 2007 (JP) JP2007-309123

(51) Int. Cl. H04H 20/48

(52) U.S. Cl. 381/14

(57) ABSTRACT

A stereo modulator converts an audio signal to a stereo composite signal. A frequency modulator receives the stereo composite signal and modulates the frequency of a carrier wave using the stereo composite signal as a modulation signal. An amplitude modulator modulates the amplitude of a sub-carrier by using, as a modulation signal, a difference signal between an L-channel and an R-channel of the audio signal. A first adder adds an output of the amplitude modulator with a sum signal of the L-channel and R-channel. A first multiplier multiplies an output of the first adder with a first variable coefficient. A second multiplier multiplies a pilot signal with a second variable coefficient. A second adder adds outputs of the first and second multipliers and outputs the resultant. A modulation degree adjuster adjusts the amplitude of the stereo composite signal and outputs the resultant signal to the frequency modulator.

### BACKGROUND OF THE INVENTION

1. Field of the Invention

The present invention relates to an FM transmitter for generating a stereo composite signal, performing frequency modulation (FM) on the signal, and outputting the resultant signal.

2. Description of the Related Art

An FM transmitter for converting an audio signal to a stereo composite signal, modulating the frequency of the signal by using a frequency modulator, and outputting the resultant signal is known. Such an FM transmitter can transmit the audio signal without using a wire such as an RCA cable, so that it is used for transmission of a signal between a CD changer in a car audio and a head unit. Further, in recent years, a hard disk audio device, a memory audio device, and a cellular phone terminal having the music reproduction function are markedly being spread. The FM transmitter is used also for the application of reproducing music data stored in such a small electronic device from a speaker of a stationary audio component or the like.

The FM transmitter converts the audio signal to the stereo composite signal, performs frequency modulation on the signal by using the stereo composite signal, amplifies the frequency-modulated signal, and outputs the amplified signal from an antenna. For generation of the stereo composite signal, a sub-carrier of 38 kHz and a pilot signal of 19 kHz are used.
[Patent document 1] Japanese Patent Application (Laid Open) No. H9-069729
[Patent document 2] Japanese Patent Application (Laid Open) No. H10-013370

The maximum frequency shift in the frequency modulation is determined in each country and each area. The value of the maximum frequency shift is, for example, 75 kHz in Japan and U.S. and 40 kHz in Europe. Therefore, in the case of constructing an FM transmitter so as to be adapted to both of the standards, when circuits are optimized in consideration of the maximum frequency shift in one of the areas, a problem occurs such that when the FM transmitter is used in the other area, the S/N ratio deteriorates.

### SUMMARY OF THE INVENTION

The present invention has been achieved in consideration of such problems and a general purpose of the present invention is to provide an FM transmitter with improved S/N ratio.

An embodiment of the present invention relates to an FM transmitter. The FM transmitter includes: a stereo modulator that converts an input audio signal to a stereo composite signal; and a frequency modulator that receives the stereo composite signal and modulates the frequency of a carrier wave using the stereo composite signal as a modulation signal. The stereo modulator includes: an amplitude modulator that modulates the amplitude of a sub-carrier by using, as a modulation signal, a difference signal between an L-channel and an R-channel of the audio signal; a first adder that adds an output of the amplitude modulator with a sum signal of the L-channel and R-channel of the audio signal; a first multiplier that multiplies an output of the first adder with a first variable coefficient; a second multiplier that multiplies a pilot signal with a second variable coefficient; and a second adder that adds outputs of the first and second multipliers and outputs the resultant.

In the embodiment, the amplitude of the pilot signal and the output of the second adder (hereinbelow, called the main/sub channel signal) can be adjusted independently by the first and second amplifiers. Thus, the mixture ratio can be optimized according to the maximum frequency shift, and the level of the pilot signal and the main/sub channel signal can be optimized with respect to the noise level, so that the S/N ratio can be improved.

The FM transmitter may further include a modulation degree adjuster that adjusts the amplitude of the stereo composite signal from the stereo modulator and outputs the resultant signal to the frequency modulator.

In this case, the stereo modulator can adjust the mixture ratio between the main/sub channel signal and the pilot signal, and the modulation degree adjuster can adjust the modulation degree.

The gain of the modulation degree adjuster is desirably variable.

The FM transmitter may be monolithically integrated on a single semiconductor substrate. “Monolithic integration” includes the case where all of components of the circuit are formed on the semiconductor substrate and the case where main components of the circuit are monolithically integrated. For adjustment of a circuit constant, a part of a resistor, a capacitor, and the like may be provided on the outside of the semiconductor substrate. By monolithically integrating the circuit, the area of the circuit can be reduced.

Another embodiment of the invention relates to an electronic device. The electronic device includes a sound source that outputs an audio signal, the FM transmitter of any of the embodiments, and an antenna that transmits an output signal of the FM transmitter to the outside.

According to the embodiment, an FM signal having an excellent S/N ratio can be transmitted irrespective of a use area.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a configuration of an electronic device using an FM transmitter of an embodiment of the invention;

FIG. 2 is a level diagram of signals of the FM transmitter of FIG. 1;

FIG. 3 is a block diagram showing the configuration of an FM transmitter as a modification; and

FIG. 4 is a circuit diagram of an FM transmitter and peripheral circuits.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the specification, “a state where a member A is connected to a member B” includes the case where the members A and B are physically directly connected to each other, and the case where the members A and B are indirectly connected to each other via another member which does not exert an influence on the electric connection state.

Similarly, “a state where a member C is provided between the members A and B” includes the case where the members A and C or the members B and C are directly connected to each other and the case where the members A and C or the members B and C are indirectly connected to each other via another member which does not exert an influence on the electric connection state.

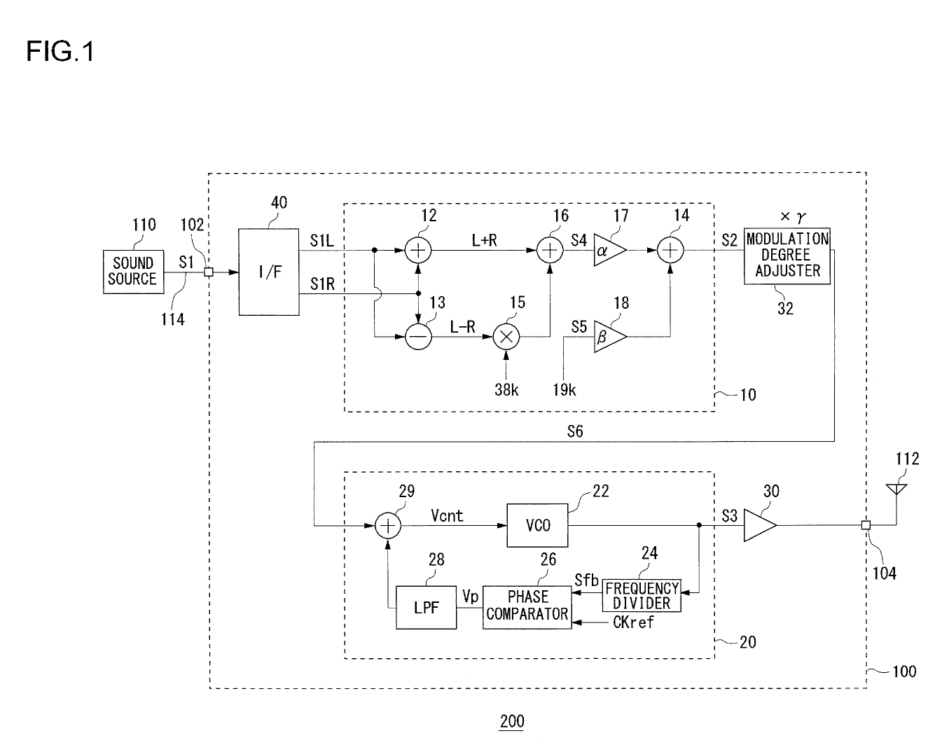

FIG. 1 is a block diagram showing a configuration of an electronic device 200 using an FM transmitter 100 of an embodiment of the invention. The electronic device 200 is, for example, a cellular phone terminal, a radio receiver, or a silicon audio player, and has an audio reproduction function. An audio signal to be reproduced can be output from an electroacoustic transducer itself such as a speaker or earphone of the electronic device 200. In addition, the electronic device 200 can frequency-modulate an audio signal and transmit the frequency-modulated audio signal as electric waves to the outside in order to realize higher sound-quality audio reproduction. The user can receive the transmitted signal by an external audio player and reproduce the received signal with higher sound quality.

The electronic device 200 has a sound source 110, the FM transmitter 100, and an antenna 112.

The sound source 110 outputs an audio signal Si. For example, the audio signal S1 may be a signal obtained by receiving and demodulating broadcast waves or a signal obtained by reproducing data stored in a memory. Any method may be used to generate the audio signal S1. The sound source 110 and the FM transmitter 100 are connected to each other via a bus 114 of a predetermined format. For example, the bus 114 is an I2S bus. In this case, the audio signal S1 is transmitted as serial data between the sound source 110 and the FM transmitter 100.

The FM transmitter 100 receives the audio signal S1 from the sound source 110. The FM transmitter 100 has an interface unit 40, a stereo modulator 10, a frequency modulator 20, and a power amplifier 30 which are monolithically integrated on a single semiconductor substrate as a functional integrated circuit (IC). FIG. 1 shows only main circuit blocks extracted, and the other blocks are not appropriately shown.

The interface unit 40 receives the audio signal S1 from the sound source 110 via an input terminal 102. The interface unit 40 receives the audio signal S1 and outputs it to the stereo modulator 10. The audio signal S1 includes an L-channel signal S1L and an R-channel signal S1R. The stereo modulator 10 performs stereo modulation on the audio signals S1L and S1R, thereby generating a stereo composite signal S2.

The frequency modulator 20 modulates the frequency of a carrier signal using the stereo composite signal S2 as a modulation signal. A frequency-modulated audio signal (hereinbelow, also called modulated signal) S3 is input to a power amplifier 30. The power amplifier 30 receives the modulated signal S3 and amplifies it. The antenna 112 is connected to an output terminal 104 of the FM transmitter 100 via a not-shown matching circuit. A frequency-modulated signal is transmitted from the antenna 112.

The configuration of the electronic device 200 has been described above.

The stereo modulator 10, a modulation degree adjuster 32, and the frequency modulator 20 will be described in detail hereinbelow.

The stereo modulator 10 includes a third adder 12, a subtracter 13, a second adder 14, an amplitude modulator 15, a first adder 16, a first multiplier 17, and a second multiplier 18. The third adder 12 adds the L-channel and R-channel audio signals S1L and S1R and generates a sum signal L+R. The subtracter 13 generates a difference signal L-R of the L-channel and R-channel audio signals S1L and S1R. The amplitude modulator 15 is a mixer and modulates the amplitude of a sub-carrier of 38 kHz by using the difference signal L−R. The first adder 16 adds the sum signal L+R with the sub-carrier output from the amplitude modulator 15. An output of the first adder 16 will be called a main/sub channel signal S4.

The first multiplier 17 multiplies the main/sub channel signal S4 with a first variable coefficient α. The second multiplier 18 multiplies a pilot signal S5 of 19 kHz with a second variable coefficient β. Each of the first and second variable coefficients α and β is at least binary values and changeable.

The second adder 14 adds an output signal of the first multiplier 17 and the pilot signal S5 from the second multiplier 18, thereby generating the stereo composite signal S2.

The modulation degree adjuster 32 receives the stereo composite signal S2 output from the stereo modulator 10. The modulation degree adjuster 32 attenuates the amplitude of the stereo composite signal S2 and adjust the modulation degree of the frequency modulator 20 as pre-process of the frequency modulator 20. The gain (attenuation factor) γ of the modulation degree adjuster 32 may be variable.

The frequency modulator 20 has a configuration including a VCO 22, a frequency divider 24, a phase comparator 26, a loop filter 28, and an adder 29. The VCO 22 oscillates at a frequency according to a control voltage Vcnt. The output signal S3 of the VCO 22 is output as a modulated signal to the outside and input to the frequency divider 24. The frequency divider 24 divides the frequency of the output signal S3 of the VCO 22 to 1/n (n: natural number), and outputs a feedback signal Sfb. The phase comparator 26 compares the feedback signal Sfb output from the frequency divider 24 with a reference clock signal CKref, and outputs a voltage according to the phase difference of the two signals (hereinbelow, called phase difference voltage Vp).

The loop filter 28 is a low pass filter, eliminates high frequency components of the phase difference voltage Vp output from the phase comparator 26, and outputs the resultant to the adder 29. The adder 29 adds the stereo composite signal S6 output from the modulation degree adjuster 32 with the output signal of the loop filter 28, and outputs the resultant as the control voltage Vcnt.

Each of the processes in the stereo modulator 10, the modulation degree adjuster 32, and the frequency modulator 20 may be performed in an analog and/or digital manner. Each of the circuits may be an analog or digital circuit.

The operation of the FM transmitter 100 constructed as described above will be described.

Although description will be given on assumption that each of signals is a digital signal, the description can be also applied to the case where the signals are analog signals. When the stereo composite signal S2, the main/sub channel signal S4, the pilot signal S5, and the like are digital signals, the full scale is specified according to the number of bits of the digital signal. Now, it is assumed that the numbers of bits of the stereo composite signal S2, the main/sub channel signal S4, and the pilot signal S5 are equal to each other and the full scale values of the signals are also equal to each other. It is assumed that the main/sub channel signal S4 and the pilot signal S5 are normalized so that their maximum amplitude is equal to the full scale.

The maximum frequency shift of the pilot signal S5 is specified as 7.5 kHz. Therefore, when the maximum frequency shift of the modulated signal S3 is 40 kHz, the maximum frequency shift of the main/sub channel signal S4 is expressed as 40−7.5=32.5 kHz. That is, it is sufficient to set the mixture ratio of the main/sub channel signal S4 and the pilot signal S5 as 32.5:7.5=0.81:0.19. When it is assumed that the full scale of the main/sub channel signal S4 and that of the pilot signal S5 are equal to each other, the mixture ratio is equal to the first variable coefficient α: the second variable coefficient β. That is, in the case of setting the maximum frequency shift to 40 kHz, α is set to 0.81 and β is set to 0.19. At this time, the stereo composite signal S2 obtained by adding the outputs of the first and second multipliers 17 and 18 becomes a full-scale signal.

On the other hand, when the maximum frequency shift of the modulated signal S3 is 75 kHz, the maximum frequency shift of the main/sub channel signal S4 is expressed as 75−7.5=67.5 kHz. Therefore, it is sufficient to set the mixture ratio of the main/sub channel signal S4 and the pilot signal S5 as 67.5:7.5=0.9:0.1. That is, when the maximum frequency shift is 75 kHz, α is set to 0.9 and β is set to 0.1. At this time as well, the stereo composite signal S2 obtained by adding the outputs of the first and second multipliers 17 and 18 becomes a full-scale signal.

In both of the cases where the maximum frequency shift is 40 kHz and 75 kHz, the maximum amplitude of the stereo composite signal S2 becomes the full scale. If the stereo composite signal S2 is output as it is to the frequency modulator 20, the maximum frequency shifts become equal to each other. Consequently, the modulation degree adjuster 32 switches the gain γ (attenuation factor) in accordance with the maximum frequency shift to attenuate the stereo composite signal S2.

In the FM transmitter 100, by providing the first and second multipliers 17 and 18, the mixture ratio of the main/sub channel signal S4 and the pilot signal S5 can be changed according to the maximum frequency shift.

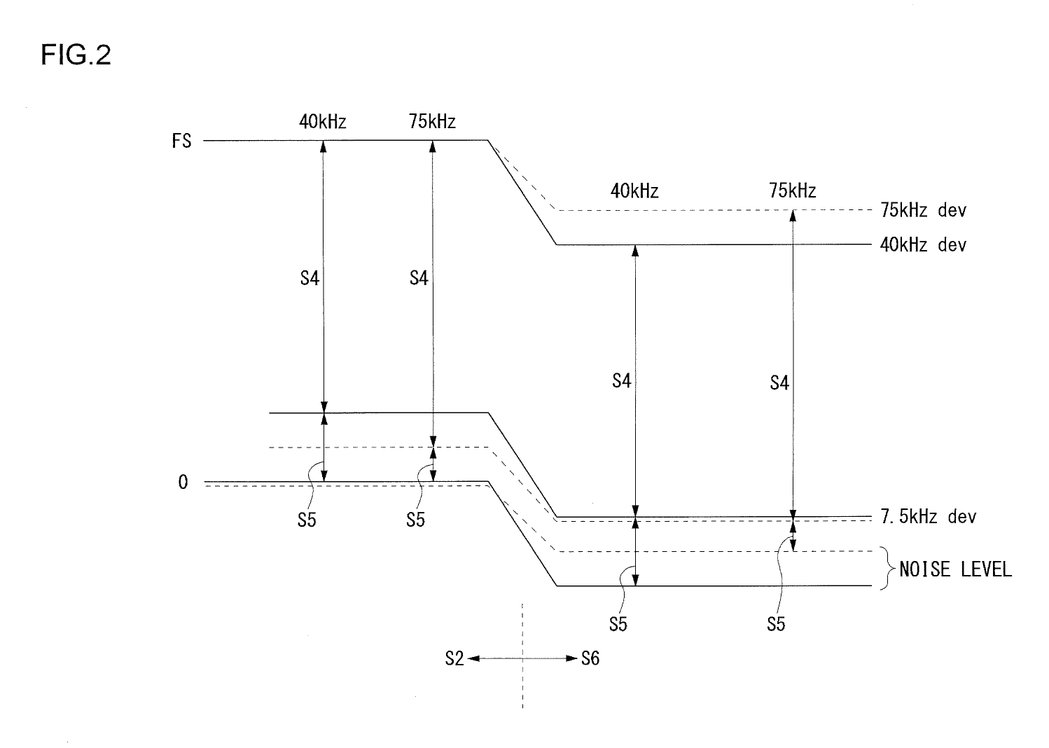

FIG. 2 is a level diagram of signals of the FM transmitter 100 of FIG. 1. In FIG. 2, the vertical axis of the stereo composite signal S2 indicates the level of a digital value from 0 to FS (Full Scale), and the vertical axis of the stereo composite signal S6 indicates the modulation degree.

When the maximum frequency shift is 40 kHz, the main/sub channel signal S4 and the pilot signal 5S are mixed at the ratio of 0.81FS:0.19FS. The resultant stereo composite signal S2 has the full scale.

When the maximum frequency shift is 75 kHz, the main/sub channel signal S4 and the pilot signal S5 are mixed at the ratio of 0.9FS:0.1FS. In this case as well, the resultant stereo composite signal S2 has the full scale.

The amplitude of the stereo composite signal S6 is adjusted by the modulation degree adjuster 32 so that the modulation degree of the pilot signal S5 of 19 kHz coincides with 7.5 kHz. At this time, the noise level also deteriorates, so that deterioration in the S/N ratio at the time of 40 kHz can be prevented.

In both of the cases where the maximum frequency shift is 40 kHz and 75 kHz, the stereo composite signal S2 has the full scale FS. In the case where the signal is any of digital and analog signals, as the amplitude is larger, the larger amount of information can be transmitted. Thus, in the embodiment, an excellent S/N ratio can be obtained.

The effects of the FM transmitter 100 of the embodiment will become apparent by the following consideration.

The case where the gain β (the second variable coefficient) of the second multiplier 18 is fixed will be considered. In this case, only the gain a of the first multiplier 17 is switched. When the circuit is optimized at 75 kHz, α is set to 0.9 and β is set to 0.1. To obtain the maximum frequency shift of 40 kHz in this state, α has to be set to 0.43. Therefore, the stereo composite signal S2 becomes 0.1FS+043FS=0.53FS. Only the information amount of about the half of the full scale can be used, and the S/N ratio deteriorates. The FM transmitter 100 of the embodiment can solve this problem as described above.

It is understood by a person skilled in the art that the embodiment is illustrative and the combination of the components and processes of the embodiment can be variously modified, and such modifications are also in the scope of the present invention.

Although the case where the sum α+β of the first variable coefficient a and the second variable coefficient β is 1 has been described above, the invention is not limited to the embodiment. As the sum α+β is closer to 1, the deterioration in the S/N ratio is suppressed. When the sum is larger than 0.53, the S/N ratio can be improved as compared with the case where β is fixed.

Although the case of providing the modulation degree adjuster 32 in the FM transmitter 100 and switching the final modulation degree between 75 kHz and the 40 kHz has been described, the modulation degree may be fixed to a constant value. In this case, it is sufficient to set the first and second variable coefficients α and β to appropriate values in consideration of the modulation degree.

In the foregoing embodiment, the case of adding two signals of the main/sub channel signal S4 and the pilot signal S5 has been described. Further another signal may be added. In the following, the case of combining data on an RDS (Radio Data System)/RBDS (Radio Broadcast Data System) (hereinbelow, called RDS/RBDS data) and performing frequency modulation will be described.

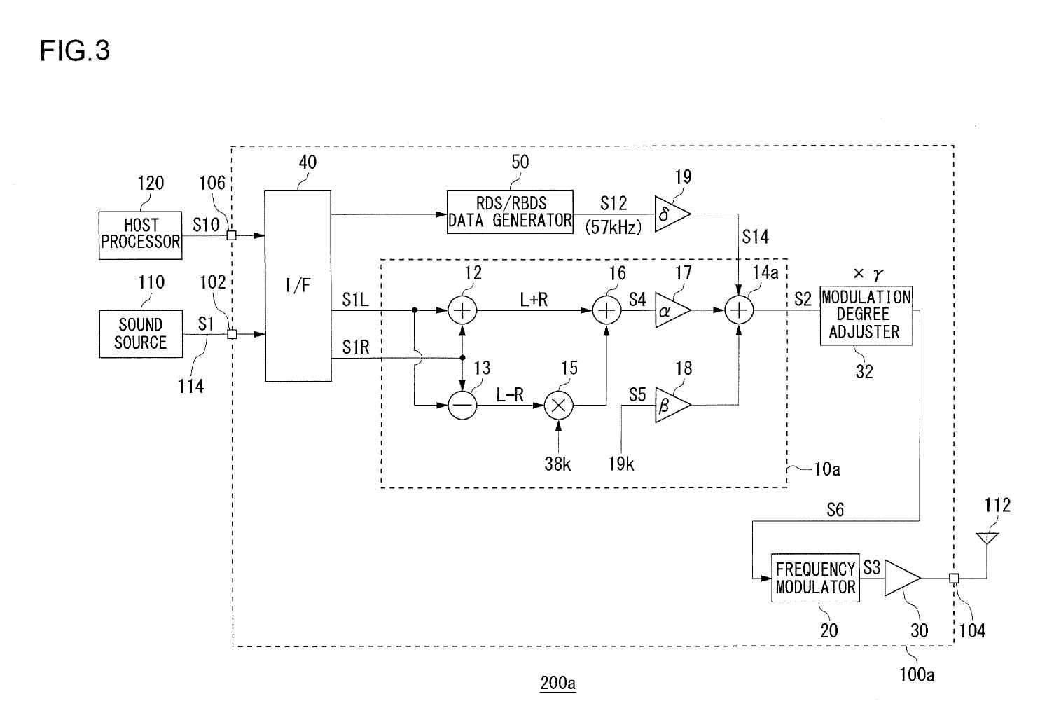

FIG. 3 is a block diagram showing the configuration of an FM transmitter of a modification. An FM transmitter 100a of FIG. 3 has, in addition to the components of the FM transmitter 100 of FIG. 1, an RDS/RBDS data generator 50 and a third multiplier 19.

A host processor 120 generates data S10 such as character information to be transmitted as RDS/RBDS data. The interface unit 40 receives the data S10 via an input terminal 106 and outputs the data S10 to the RDS/RBDS data generator 50. Generally, the RDS/RBDS data generator 50 includes a differential encoder, a phase shift keying device, a filter, and an amplitude modulator. The differential encoder receives the RDS/RBDS data S10 and performs differential encoding on the data. The phase shift keying device performs binary phase shift keying (BPSK) on the differentially encoded signal. High frequency components of the signal subjected to the BPSK are removed by a filter for spectrum shaping. The amplitude modulator modulates the amplitude of a sub-carrier of 57 kHz using an output of the filter as a modulation signal. The RDS/RBDS data generator 50 outputs data (hereinbelow, called RDS/RBDS data) S12 obtained by modulating the amplitude of the sub-carrier of 57 kHz.

The third multiplier 19 multiplies the RDS/RBDS data S12 of 57 kHz with a third variable coefficient δ and outputs the resultant data as data S14. The third variable coefficient δ has at least binary values and is changeable like the first and second variable coefficients α and β.

A second adder 14a of the stereo modulator 10a adds output data of the first, second, and third multipliers 17, 18, and 19 and outputs the resultant data to the modulation degree adjuster 32. The modulation degree adjuster 32 multiplies the stereo composite signal S2 with the gain γ and outputs the resultant signal to the frequency modulator 20.

The relations of Ε, β, γ, and δ will now be described. The maximum frequency shift of the pilot signal S5 is 7.5 kHz, and the maximum frequency shift of the RDS/RBDS data S12 lies in the range of 1.0 to 7.5 kHz. In the following, it is assumed that the maximum frequency shift of the RDS/RBDS data S12 is 2.5 kHz. It is sufficient for the coefficients α, β, and δ to satisfy the relation (α+β+δ)≦1FS.

In the case where the maximum frequency shift is 75 kHz, when α=0.867, β=0.1, and δ=0.033, the modulation degree of the main/sub channel signal S4 is about 65 kHz (75 kHz×0.867), the modulation degree of the pilot signal S5 is equal to 7.5 kHz (=75 kHz×0.1), and the modulation degree of the RDS/RBDS data S12 is about 2.5 kHz (75 kHz×0.033).

In the case where the maximum frequency shift is 40 kHz, when α=0.747, β=0.19, and δ=0.063, the modulation degree of the main/sub channel signal S4 is about 30 kHz (40 kHz×0.747), the modulation degree of the pilot signal 5S is about 7.5 kHz (40 kHz×0.19), and the modulation degree of the RDS/RBDS data S12 is about 2.5 kHz (40 kHz×0.063).

As described above, also in the FM transmitter 100a of FIG. 3, by multiplying the RDS/RBDS data S12 with the third variable coefficient δ and adding the resultant, the full scale FS can be utilized. The technique can be also applied to data other than the RDS/RBDS data S12.

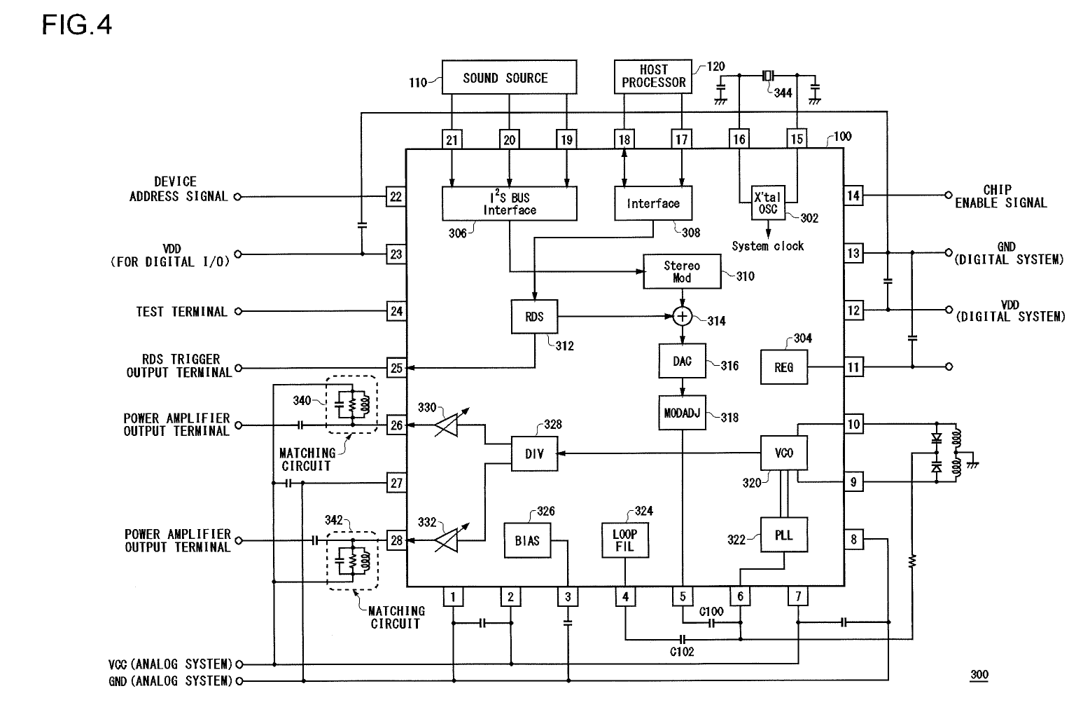

FIG. 4 is a circuit diagram showing the FM transmitter 100 and the peripheral circuits. The IC of the FM transmitter 100 has first to 28th pins.

To the first, second, seventh, eighth, and 27^{th} pins, the power supply voltage Vcc for analog circuits in the FM transmitter 100 and the ground voltage GND are supplied. To the 12^{th}, 13^{th}, and 23^{rd} pins, the power supply voltage Vdd for digital circuits and the ground voltage GND are supplied.

A regulator 304 generates voltage used in an internal logic of the FM transmitter 100. From the 11^{th} pin, the voltage generated by the regulator 304 is output.

To the 19^{th} to 21^{st} pins, the sound source 110 is connected via the I2S bus. The 19^{th} pin is for data, the 20^{th} pin is for clocks, and the 21^{st} pin is for LR clocks. An I2S bus interface unit 306 transmits/receives data to/from the sound source 110.

To the 17^{th} and 18^{th} pins, the host processor 120 is connected via the I2C bus. The 17^{th} pin is for a clock signal, and the 18^{th} pin is for a data signal.

To the 15^{th} and 16^{th} pins, a crystal oscillator 344 is connected. An oscillator 302 provides a system clock.

A chip enable signal is input to the 14^{th} pin. By the chip enable signal, the FM transmitter 100 is switched between a normal operation mode and a power-down mode. In the power-down mode, internal circuits are shut down, current consumption becomes almost zero, and signals from the outside are not accepted.

To the 22^{nd} pin, a device address selection signal is input. When an LSI controlled by a common I2C bus exists other than the FM transmitter 100, the 22^{nd} pin is provided to distinguish between the FM transmitter and the LSI.

The 24^{th} pin is a terminal for test.

The 25^{th} pin is a trigger output signal for RDS. An RDS digital modulator 312 notifies the circuit blocks other than the FM transmitter 100 via the 25^{th} pin of the fact that an RDS signal is transmitted from the outside to the FM transmitter 100.

A stereo modulator 310 receives an audio signal received from the sound source 110 and stereo-modulates the audio signal, thereby generating a stereo composite signal. The RDS digital modulator 312 sequentially reads data from the host processor 120, performs binary phase shift keying, filters the data, and outputs the resultant data. An adder 314 adds RDS/RBDS data output from the RDS digital modulator 312 with the stereo composite signal.

A DAC 316 digital-analog-converts an output of the adder 314. The amplitude of the DAC 316 is adjusted by a modulation degree adjuster 318, and the resultant data is supplied to a PLL 322 via the fifth pin, an external capacitor C100, and the sixth pin. The sixth pin is connected to a loop filter 324 via a capacitor C102 and the fourth pin (PLL time constant switching terminal). The loop filter 324 is formed by the capacitor C102 connected to the fourth pin and a not-shown resistor in the FM transmitter 100. By changing the capacitance value of the capacitor C102 or changing the resistance value, the time constant is adjusted.

A VCO 320 oscillates at a frequency according to a signal from the PLL and supplies a frequency-modulated signal to a divider 328. To the VCO 320, a variable capacitance diode and an inductor are connected via the ninth and tenth pins.

The FM transmitter 100 has power amplifiers of two systems. The divider 328 outputs signals to power amplifiers 330 and 332. An output of the power amplifier 330 is output from the 26^{th} pin to the outside. To the 26^{th} pin, a matching circuit 340 is connected. An output of the power amplifier 332 is supplied from the 28^{th} pin to the outside. To the 28^{th} pin, a matching circuit 342 is connected. By providing the two systems of the power amplifiers and matching circuits, the frequency characteristic can be adjusted according to a load (antenna) of each of the systems.

The correspondence between FIGS. 1 and 4 is as follows.
Interface unit 40: interface 306
Stereo modulator 10: stereo modulator 310
Modulation degree adjuster 32: modulation degree adjuster 318
Frequency modulator 20: loop filter 324, PLL 322, VCO 320
Power amplifier 30: divider 328 and power amplifiers 330 and 332

While the preferred embodiments of the present invention have been described using specific terms, such description is for illustrative purposes only, and it is to be understood that changes and variations may be made without departing from the spirit or scope of the appended claims.

1. An FM transmitter comprising:
a stereo modulator that converts an input audio signal to a stereo composite signal; and
a frequency modulator that receives the stereo composite signal and modulates the frequency of a carrier wave using the stereo composite signal as a modulation signal,
wherein
the stereo modulator comprises:
an amplitude modulator that modulates the amplitude of a sub-carlier by using, as a modulation signal, a difference signal between an L-channel and an R-channel of the audio signal;
a first adder that adds an output of the amplitude modulator with a sum signal of the L-channel and R-channel of the audio signal;
a first multiplier that multiplies an output of the first adder with a first variable coefficient;
a second multiplier that multiplies a pilot signal with a second variable coefficient; and
a second adder that adds outputs of the first and second multipliers and outputs the resultant.

2. The FM transmitter according to claim 1, further comprising a modulation degree adjuster that adjusts the amplitude of the stereo composite signal from the stereo modulator and outputs the resultant signal to the frequency modulator.

3. The FM transmitter according to claim 2, wherein
gain of the modulation degree adjuster is variable.

4. The FM transmitter according to claim 1, wherein
the FM transmitter is monolithically integrated on a single semiconductor substrate.

5. An electronic device comprising:
a sound source that outputs an audio signal;
an FM transmitter that receives the audio signal,
an FM transmitter comprising:
a stereo modulator that converts an input audio signal to a stereo composite signal; and
a frequency modulator that receives the stereo composite signal and modulates the frequency of a carrier wave using the stereo composite signal as a modulation signal,
wherein
the stereo modulator comprises:
an amplitude modulator that modulates the amplitude of a sub-carlier by using, as a modulation signal, a difference signal between an L-channel and an R-channel of the audio signal;
a first adder that adds an output of the amplitude modulator with a sum signal of the L-channel and R-channel of the audio signal:
a first multiplier that multiplies an output of the first adder with a first variable coefficient;
a second multiplier that multiplies a pilot signal with a second variable coefficient; and
a second adder that adds outputs of the first and second multipliers and outputs the resultant; and
an antenna that transmits an output signal of the FM transmitter to the outside.
